(19) United States
(12) Patent Application Publication
(10) Pub. No.: US 2025/0390236 A1
(43) Pub. Date: Dec. 25, 2025

(54) DYNAMICALLY ALLOCATING CAPACITY IN DIFFERENT RAS MODES

(71) Applicant: Micron Technology, Inc., Boise, ID (US)

(72) Inventors: Rishabh Dubey, Agrate Brianza (IT); Daniele Balluchi, Cernusco Sul Naviglio MI (IT); Emanuele Confalonieri, Segrate (IT); Marco Sforzin, Cernusco Sul Naviglio MI (IT); Massimiliano Patriarca, Milano (IT)

(21) Appl. No.: 19/239,645

(22) Filed: Jun. 16, 2025

Related U.S. Application Data
(60) Provisional application No. 63/663,306, filed on Jun. 24, 2024.

(51) Int. Cl. G06F 3/06

(52) U.S. Cl. CPC G06F 3/0631; G06F 3/0604; G06F 3/064; G06F 3/0679

(57) ABSTRACT

A system may include memory including memory blocks and a memory device processor configured to dynamically allocate the memory blocks in different RAS (Reliability, Availability and Serviceability) modes that have different power and reliability characteristics. The memory device processor may be configured to dynamically allocate a first of the memory blocks in a first RAS mode and dynamically allocate a second of the memory blocks in a second RAS mode. Benefits include flexibility in allocating memory for different uses to appropriately balance performance and reliability and thus improve overall system performance.

### PRIORITY APPLICATION

This application claims the benefit of priority to U.S. Provisional Application Ser. No. 63/663,306, filed Jun. 24, 2024, which is incorporated herein by reference in its entirety.

### TECHNICAL FIELD

This document relates generally to computer storage devices, and more particularly but not limited to systems, devices and methods for allocating storage device resources.

### BACKGROUND

Large capacity and high bandwidth memories are desirable for computer systems that implement data-intensive applications such as machine learning, artificial intelligence, and analytics. To support these emerging data-rich and compute-intensive applications, the compute express link (CXL) protocol has been developed. CXL is an industry open standard interface for high-speed communications. CXL memory includes a Dynamic Capacity Device (DCD) (see CXL 3.0 spec 9.13.3). A benefit of CXL and DCD is that memory can be added through CXL ports and that the memory may be configured as pooled memory where portions of the pooled memory may be allocated to and released by hosts. Pooled memory improves memory utilization as memory may be shared among hosts. Additionally, simpler memory access instructions may be used similar to host-attached memory. Scalability is another benefit.

Design considerations for memory devices may balance competing RAS (Reliability, Availability, Serviceability) characteristics. Reliability refers to the ability of the system to reliably or consistently perform as expected. Availability relates to a percentage of time that the system is functional over the time that it is expected to be functional. Serviceability relates to how easy or difficult it is to diagnose problems, obtain parts, repair the system to be operable again, and the like. These RAS characteristics are competing as improvements in reliability may decrease performance or bandwidth and increase the total cost of ownership, and reductions in the total cost of ownership or increasing performance may decrease reliability. There is a need for improved memory management for balancing these competing demands.

### BRIEF DESCRIPTION OF THE DRAWINGS

Various embodiments are illustrated by way of example in the figures of the accompanying drawings. Such embodiments are demonstrative and not intended to be exhaustive or exclusive embodiments of the present subject matter.

FIG. 1 illustrates, by way of example and not limitation, competing demands of power and performance (bandwidth) for different RAS technologies.

FIG. 2 illustrates, by way of example and not limitation, reliability matrices identifying annual failure rate (AFR) and silent data corruption (SDC) characteristics for some RAS technologies.

FIG. 3 illustrates, by way of example and not limitation, a host connected to a CXL device.

FIG. 4 illustrates, by way of example and not limitation, a CXL system including a dynamic capacity device (DCD) configured to allocate memory with RAS modes.

FIG. 5 illustrates, by way of example and not limitation, a 16-channel memory block in a reliable mode.

FIG. 6 illustrates, by way of example and not limitation, a 16-channel memory block in a performance mode.

FIG. 7 illustrates, by way of example and not limitation, a block index table for a DCD configured to allocate memory in different RAS modes.

FIG. 8 illustrates, by way of example and not limitation, a DCD embodiment configured to allocate memory in different RAS modes.

FIG. 9 illustrates, by way of example and not limitation, a method performed by a DCD to process a read or write request to memory

FIG. 10 illustrates, by way of example and not limitation, a method performed by a DCD in response to a request to add a capacity block.

FIG. 11 illustrates, by way of example and not limitation, a method performed by a DCD in response to a request to release a capacity block.

FIG. 12 illustrates, by way of example and not limitation, an embodiment of a DCD along with operational flow.

FIG. 13 illustrates, by way of example and not limitation, a flow for dynamically allocating memory for a host.

FIG. 14 illustrates, by way of example and not limitation, a relationship between power and bandwidth for Reliable (e.g., RAID, Reed Solomon, CK) and Performance (e.g., CRC, modified RS plus CRC, noCK) RAS modes, and further illustrates a benefit for optimizing capacities in Reliable Mode and Performance Mode.

### DETAILED DESCRIPTION

The compute express link (CXL) protocol is an industry open standard interface for high-speed communications used in support of emerging data-rich and compute-intensive applications such as artificial intelligence, machine learning and analytics. The CXL interface can allow systems to significantly improve performance while reducing total cost of ownership. CXL enables efficient communication between processors, memory devices, and accelerators which offload some tasks from the central processing unit (CPU). CXL maintains memory coherency between the CPU memory space (e.g., the host memory or caches maintained by the host) and memory on attached devices or accelerators. Some benefits include resource sharing and lower overall system costs. For example, CXL may enable servers to be composed with higher memory capacity and low latency to meet application needs, as memory capacity may be scaled, integrated and expanded for application workloads.

Memory devices may be designed to implement dynamic capacity, which enables dynamic changes to memory capacity without resetting the memory device. For example, a Dynamic Capacity Device (DCD) allows for both shared and pooled memory. Shared memory is accessible by all processors in a system such that each processor may read from and write to the shared memory. Shared memory makes it easy to share and communicate data because different processors may share data by accessing the same block of memory rather than performing complicated data transfers. Since the shared memory can be accessed as needed without data transfer communication over a network, the shared memory reduces latency and power consumption. Pooled memory is an efficient use of the memory. A memory controller, which may be referred to herein as processing circuitry, manages the memory by dynamically allocating or deallocating memory for use by specific processor(s). Each processor (e.g., host) may be allocated its own dedicated memory, which guarantees access to the memory, avoids interference from other processors, and improves system security from malicious code because of the isolated pools of memory.

Emerging data-rich and compute-intensive processing applications such as artificial intelligence, machine learning and analytics have placed significant and competing demands on memory systems used in data centers. These competing demands include power, performance and reliability. Reduced energy expense significantly improves the operational cost over the lifespan of a data center. It is therefore desirable to optimize the energy consumption without compromising performance, thereby enhancing the performance per-watt matrices and improving scalability by allowing scaling without encountering increases in cost due to thermal and power output limitations such as may be found in standard storage device designs (e.g., E3 family form factor used in servers and storages like a Short Thin E3 (E3.S) form factor that mechanically fits an X16 card edge and is intended for NVMe SSDs (Non-Volatile Memory Express Solid State Drive) with ×4 PCIe (Peripheral Component Interconnect Express) link widths). For example, it is desirable for a low powered memory solution to keep its power usage within a 40W power envelope as capacity is increased, e.g., to 256 GB or 512 GB.

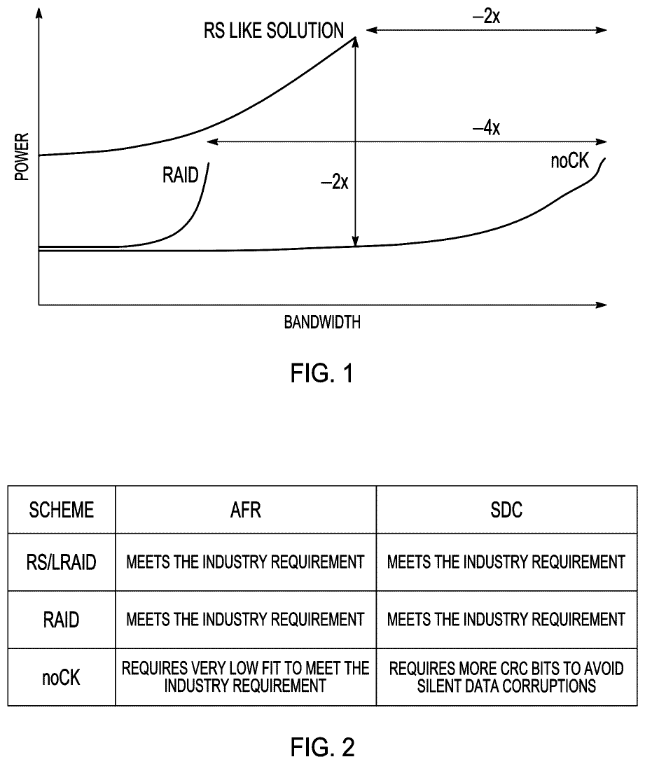

FIG. 1 illustrates, by way of example and not limitation, competing demands of power and performance (bandwidth) for different RAS technologies. FIG. 2 illustrates, by way of example and not limitation, reliability matrices identifying annual failure rate (AFR) and silent data corruption (SDC) characteristics for some RAS technologies. The reliability characteristics found in FIG. 2 may be balanced against the power and bandwidth characteristics illustrated in FIG. 1. These figures illustrate that different technologies balance the competing demands of power, performance (e.g., bandwidth) and reliability differently. For example, Reed-Solomon (RS)/LRAID characteristics include good bandwidth and good reliability (meeting the industry requirements for AFR and SDC) at the expense of higher power consumption. RAID characteristics include good reliability (meeting the industry requirements for AFR and SDC) and low power at the expense of bandwidth. Chip Kill (CK) is a known error checking and correcting (ECC) memory technology. In contrast, NoCK may use an industry standard RS1 (Reed Solomon 1) and CRC (cyclic redundancy check), and characteristics of NoCK may include low power consumption and better bandwidth compared to RAID and RS like solutions. However, NoCK is less reliable than other RAS technologies as NoCK requires very low FIT (Failures In Time) to meet the industry requirement for AF and requires more CRC bits to avoid SDC.

Different memory applications may place different relative values on the power, performance and reliability characteristics of the memory. NoCK may be more desirable for some memory applications, RAID may be more desirable for other memory application, and RS-like solutions may be more desirable for yet other memory applications. The different RAS technologies referenced within FIGS. 1 and 2 are nonexclusive examples of different RAS (reliability, availability, serviceability) modes. With respect to memory systems, RAS may refer to design considerations such as detection of data errors in the memory, redundancy or duplication in data storage, and recoverability of data when bad data is detected. Examples of RAS may include schemes such as Die SEC (single error correction on the memory die), RAID (redundant array of independent drives), RS (Reed Solomon error correcting codes), ECC (error correction code) that uses a parity bit or non-ECC that does not use a parity bit. An example of ECC memory technology includes Chipkill (“CK”) technology.

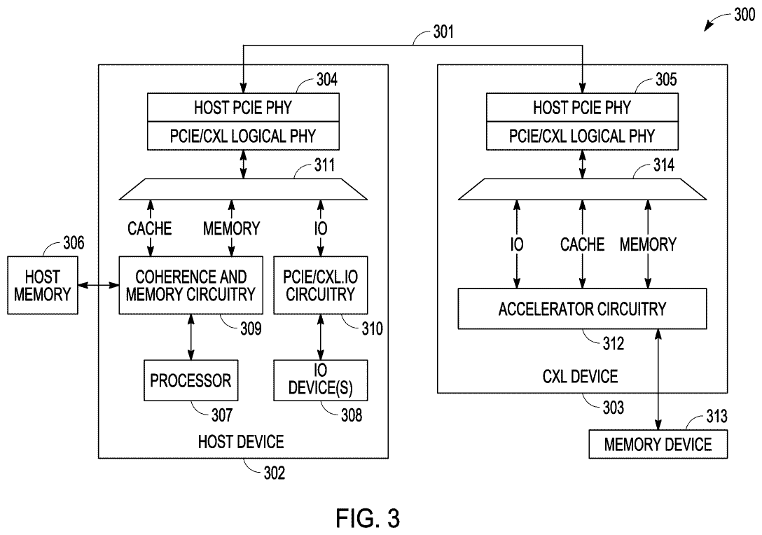

FIG. 3 illustrates, by way of example and not limitation, a host connected to a CXL device. FIG. 3 generally illustrates an example of a CXL system 300 that uses a CXL link 301 to connect a host device 302 and a CXL device 303 via a host physical layer PCIE interface 304 and a CXL client physical layer PCIE interface 305 respectively. In an example, the host device 302 includes a memory system and a portion of the host device 302 or the CXL device 303 may include a memory system command manager. The CXL link 301 may support communications using multiplexed protocols for caching (e.g., CXL.cache), memory accesses (e.g., CXL.mem), and data input/output transactions (e.g., CXL.io). CXL.io may include a protocol based on PCIe for functions such as device discovery, configuration, initialization, I/O virtualization, and direct memory access (DMA) using non-coherent load-store, producer-consumer semantics. CXL.cache may enable a device to cache data from the host memory (e.g., from the host memory 306) using a request and response protocol. CXL.memory can enable the host device 302 to use memory attached to the CXL device 303, for example, in or using a virtualized memory space. In an example, CXL.memory transactions may be memory load and store operations that run downstream from or outside of the host device 302.

The host device 302 may include a host processor 307 (e.g., comprising one or more CPUs or cores) and IO device(s) 308. The host device 302 may include, or may be coupled to, host memory 306. The host device 302 may include various circuitry (e.g., logic) configured to facilitate CXL-based communications and transactions with the CXL device 303. For example, the host device 302 may include coherence and memory circuitry 309 configured to implement transactions according to CXL.cache and CXL.mem semantics, and the host device 302 may include PCIe circuitry 310 configured to implement transactions according to CXL.io semantics. In an example, the host device 302 may be configured to manage coherency of data cached at the CXL device 303 using, e.g., its coherence and memory circuitry 309.

The host device 302 may include a host multiplexer 311 configured to modulate communications over the CXL link 301 (e.g., using the PCle PHY layer). The multiplexing of protocols ensures that latency-sensitive protocols (e.g., CXL.cache and CXL.memory) have the same or similar latency as a native processor-to-processor link. In an example, CXL defines an upper bound on response times for latency-sensitive protocols to help ensure that device performance is not adversely impacted by variation in latency between different devices implementing coherency and memory semantics. The CXL device 303 may include accelerator circuitry 312. In an example, the CXL device 303 may comprise, or can be coupled to, CXL device memory 313. The CXL device 303 may include various circuitry configured to facilitate CXL-based communications and transactions with the host device 302 using the CXL link 301. For example, the accelerator circuitry 312 may be configured to implement transactions according to CXL.cache, CXL.mem, and CXL.io semantics. The CXL device 303 may include a CXL device multiplexer 314 configured to control communications over the CXL link 301. The accelerator circuitry 312 may be one or more processors that perform one or more tasks. The accelerator circuitry 312 may be a general-purpose processor or a processor designed to accelerate one or more specific workloads.

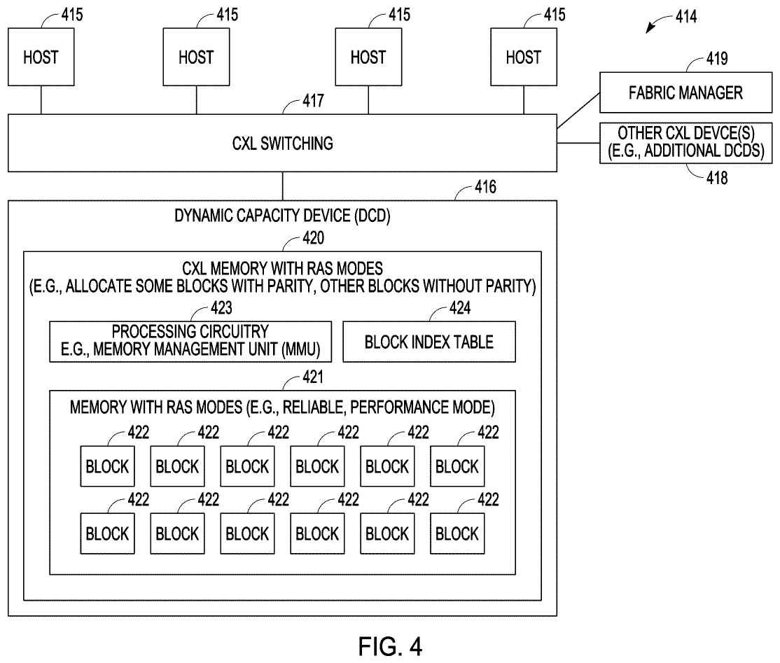

FIG. 4 illustrates, by way of example and not limitation, a CXL system including a dynamic capacity device (DCD) configured to allocate memory with RAS modes. The CXL system 414 may include one or more hosts 415 and at least one dynamic capacity device (DCD) 416. The hosts 415 may be similar to host 302 in FIG. 3. The DCD 416 is an example of a CXL device, and may be similar to CXL device 303 in FIG. 3. CXL switching circuitry 417 enables the hosts 415 to be operably connected to the DCD 416 in a manner similar to host-attached memory. Other CXL device(s) 418 (e.g., other DCDs to provide additional capacity) may be connected via the CXL switching circuitry 417. A Fabric Manager (FM) 419 may provide the application logic for system composition and allocation of resources in a CXL system 414. The FM 419 may logically connect CXL switch ports to any host to assign resources to the host. In FIG. 4, the FM 419 is illustrated as a separate device. However, the FM may reside elsewhere such as in firmware of a CXL switch or another CXL device or in a host.

The illustrated DCD 416 is configured to provide CXL memory with RAS modes 420 that may be dynamically allocated to any one or more of the hosts. The CXL memory with RAS modes 420 may include pooled and shared capacity. The total capacity of the CXL memory may be illustrated as memory 421 with a plurality of memory blocks 422 that may be allocated to the host(s). The illustrated DCD includes processing circuitry (e.g., a memory controller or a memory management unit) 423 and a block index table 424 which may be used to control and maintain the allocations of blocks to hosts. A host may request additional capacity (or release capacity) and the processing circuitry in the DCD may allocate one or more blocks to the host (or release one or more blocks) in response to that request by updating the block index table. Block(s) may be exclusively allocated to only one host or block(s) may be allocated to two or more hosts as shared memory. That is, a DCD may include both shared memory with memory blocks shared by two or more processors and pooled memory with data blocks allocated only to individual processors.

The illustrated DCD 416 is configured to have CXL memory with RAS modes 420. The DCD may support two or more RAS modes that have different characteristics related to reliability, power and performance. For example, the two or more RAS modes may include a “reliable mode” and a “performance mode.” The reliable mode provides better reliability while compromising on performance. For example, to provide better reliability benefits, a RAID-like solution with a parity bit may be used with significant impact on performance (˜50% lower) compared to RS (Reed-Solomon) like solution. The performance mode has better performance while compromising reliability. For example, to improve performance, a no-CK (RS1+CRC) or other similar solution without parity may be used which boosts the performance, however at the expense of reduced reliability.

The RAS modes are not limited to a performance mode and a reliable mode. The present subject matter is not limited to two RAS modes. The RAS modes may correspond to different combinations of performance characteristics and reliability characteristic or may be based on one of performance characteristics or reliability characteristics. The characteristics may correspond to different combinations of performance levels and reliability levels. For example, if the performance is only characterized as one of a first or second level of performance (e.g., better performance or lesser performance) and the reliability is only characterized as either a first or second level of reliability (e.g., better reliability and lesser reliability), then the two RAS modes may include a first RAS mode corresponding to a better reliability and lesser performance (e.g., reliable mode) and a second RAS mode corresponding to a better performance and lesser reliability (e.g., performance mode). The characterization for at least one of reliability or performance may have more than two levels. For example, RAS modes may be characterized by unique combinations of any one of three possible levels of reliability and any one of two possible levels of performance, or RAS modes may be characterized by unique combinations of any one of two possible levels of reliability and any one of three possible levels of performance. Similarly, RAS modes may be characterized by unique combinations of any one of three or more possible levels of reliability and any one of three or more possible levels of performance. A given one of these RAS modes may represent a desirable balance for weighting reliability and performance for a given application of the system. Two RAS modes may be identified using a single bit. By way of example, up to four RAS modes may be identified using two bits and up to eight RAS modes may be identified using three bits.

Therefore, by way of a nonexclusive example, the RAS modes may include a mode (e.g., reliable mode) in which some memory blocks are allocated with parity and a mode (e.g., performance mode) in which some memory blocks are allocated without parity. For example, a host may favor reliability over bandwidth for an application and request added capacity in the reliable mode, and the DCD may respond by allocating memory block(s) in the reliable mode (e.g., block(s) with parity). Similarly, a host may favor bandwidth over reliability for an application and request added capacity in the performance mode, and the DCD may respond by allocating memory block(s) in the Performance Mode (e.g., block(s) without parity).

In an example, the DCD 416 advertises its total capacity available to the hosts 415. For example, a 256 GB device may publish to hosts during initialization that it has 256 GB capacity. A host may request to add/release capacity during operation. For example, a first host may request 64 GB of added capacity. The DCD may allocate one or more memory blocks corresponding to the 64 GB of physical capacity to the first host and the first host may then write to and read from those allocated memory block(s). A second host may request 192 GB of added capacity, and the DCD may allocate memory blocks corresponding to 192 GB of physical capacity to the second host. Thus, the DCD may allocate capacity to host(s) as that capacity is needed. The host(s) may release that capacity when it is no longer needed. For example, the second host may release 64 GB of capacity, and the DCD may subsequently advertise that it currently has 64 GB of capacity available. The first host may request 32 GB of the newly-released 64 GB of capacity that is available, and a third host may request the other 32 GB of the newly-released 64 GB of capacity. The DCD may allocate the 32 GB of additional physical capacity to the first host and may allocate the other 32 GB of physical capacity to the third host. Thus, the DCD can advertise its available memory capacity and the host system may allocate or release capacity from a pool based on needs that can change over time.

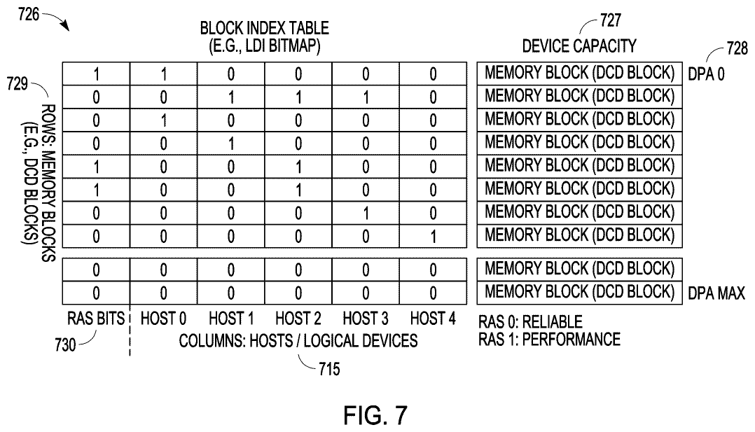

The DCD supports a mechanism to maintain knowledge about ownership of particular memory resources. For example, a logical device index (LDI), also referred to as a block index table (see FIG. 7), may provide an allocation bitmap that is maintained for each resource or capacity block. When a capacity is added to a logical device, the corresponding bit may be set for the logical device. All CXL.mem read or write operations check the allocation bit to allow or restrict the accesses to the device physical addresses (DPAs) associated with the capacity block.

According to various embodiments, a RAS bit may be introduced for each capacity block or memory block, which also may be referred to as a dynamic capacity block. The FM 419 may request a host to identify a RAS mode in which requested capacity is to be added (e.g., in a performance RAS mode or reliable RAS mode). Alternatively, a host may create dynamic capacity regions with RAS modes such as a performance capacity region and a reliable capacity region. However, in this case, capacity is allocated in the RAS mode upfront. The CXL device control may check the RAS bit along with an allocation bit and pass RAS mode information to access the media in different RAS modes. For example, accessing the media is different depending whether parity data is being stored and checked.

A DCD may support the different RAS modes at boot time. To simplify the discussion, this disclosure refers to two RAS modes and identifies those two RAS modes as reliable mode and performance mode. In an example, the reliable mode uses parity and the performance mode does not. It is noted that the system may be configured to support additional RAS modes and/or other RAS modes. For example, the DCD may dynamically allocate capacity in either the reliable mode or the performance mode based on memory uses.

As noted previously, the FM 419 may provide the application logic for system composition and allocation of resources in a CXL system, including logically connecting CXL switch ports to any host to assign resources to the host. The FM 419 may request host(s) 415 (which also may be referred to as providing a hint) to identify if it wants to add capacity and to identify the requested RAS mode for the requested capacity. In an example, the FM 419 may provide a hint whether the capacity allocation is required or requested to be in the performance mode or the in the reliable mode. In an example, a host 415 may request 64 GB of capacity in the performance mode (e.g., no parity), The DCD may find free physical capacity, i.e., capacity available in the CXL system but not already allocated to a host. A block index table may be updated to indicate that this 64 GB of physical capacity is allocated to a specific host and may also be updated to update a RAS bit in the block index table to indicate the RAS mode for this allocated memory.

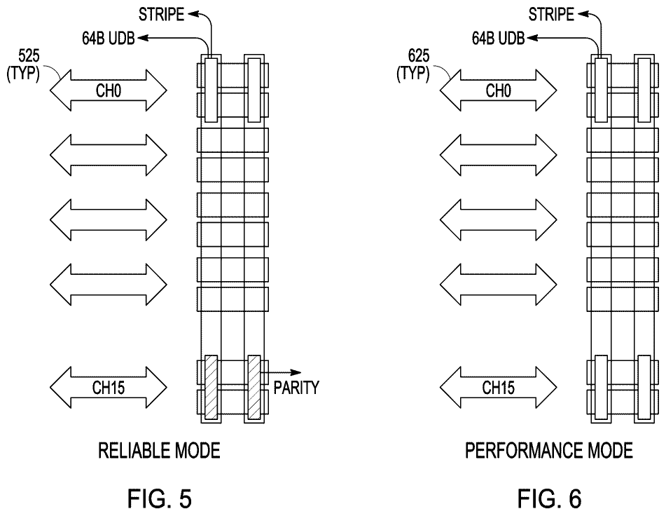

FIG. 5 illustrates, by way of example and not limitation, a 16-channel memory block in a reliable mode. FIG. 6 illustrates, by way of example and not limitation, a 16-channel memory block in a performance mode. Each memory block channel 525 in FIG. 5 and each memory block channel 525 in FIG. 6 may have 64 bytes (B) for a Universal Database (UDB). Although the memory block may have 16 channels used for data, the device may have one or more other channels, such as a 17th channel (CH16). In the reliable mode illustrated in FIG. 5, 16 of these channels (CH0 through CH15) may be used for data and the last channel (CH16) may be used for parity. An XOR function may be performed on the data and the XOR result may be written in the channel. In the performance mode illustrated in FIG. 6, none of the channels 625 are used for parity. Thus, at least CH0 through CH15 are used for data. To simplify addressing among memory blocks allocated with different RAS modes so that they use the same addressing, the 17th channel (CH16) may simply be unused in the performance mode. However, more complex addressing may be implemented that is capable of using the 17th channel (CH16) in addition to the other channels (CH0 through CH15) for data when the memory block is allocated in the performance mode.

Performing memory operations for the reliable mode takes more steps, and therefore more resources, than performing the memory operations in the performance mode. For example, writing stripe data in the Reliable Mode includes reading the old data, reading the old parity, writing the new data and writing the new parity. In contrast, writing data in the performance mode simply involves overwriting the data. Thus, as additional operations are performed for the reliable mode compared to the performance mode, the memory operations in the reliable mode consume more power and take longer.

FIG. 7 illustrates, by way of example and not limitation, a block index table 726 for a DCD configured to allocate memory in different RAS modes. The block index table 726, which may be an example of the block index table 424 in FIG. 4, may also be referred to as a Logical Device Index (LDI) table. The right side illustrates the total device capacity 727 divided into memory blocks 728, which may be an example of blocks 422 in FIG. 4. The memory blocks may also be referred to as DCD blocks as they are capable of being dynamically allocated. Each memory block corresponds to a device physical address (DPA). Columns 715 in the table may correspond to different hosts (or logical devices) that are in the CXL system and are able to request capacity from the DCD. The rows 729 correspond to the memory blocks 728. For example, there may be 256 rows of 1 GB data memory blocks for a DCD with 256 GB of capacity. A host may request 10 GB, for example, and the DCD may allocate 10 of the memory blocks to the host. A “1” value for an allocation bit in the table may be used to indicate that a memory block (row) is allocated to a host (column), and a “0” value for the allocation bit in the table may be used to indicate that a memory block is not allocated to the host. Some of the memory blocks are exclusively allocated to only one host (e.g., only one “1” value in a row), and some of the memory blocks are shared by two or more hosts (e.g., two or more “1” values in a row). Some hosts may be allocated one or blocks (e.g., one or more “1” value in a column). Some memory blocks may not be currently allocated. In the illustrated figure, the last two rows only have “0” values. These blocks may never have been previously allocated or may have been released by one of the hosts. The DCD may advertise that these blocks (e.g., the blocks corresponding to the last two rows) are available to be allocated. The block index table 726 is updated as capacity (memory block(s)) are dynamically added or released by host(s).

In an example, the table includes at least one RAS bit column 730 to indicate a RAS mode. If there are only two RAS modes, the RAS modes may be identified using a single RAS bit. For example, a “0” value for a RAS bit may indicate a reliable mode and a “1” value for the RAS bit may indicate a performance mode for the corresponding memory block. More than one bit (more than one column) may be used if there are more than two RAS modes. The RAS mode selection is at the same granularity as the add/release capacity granularity.

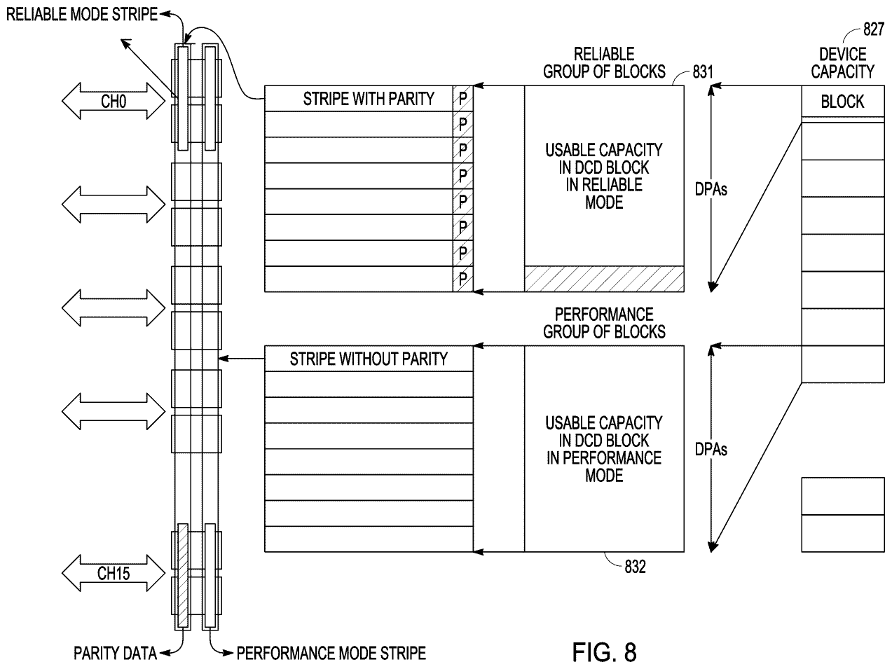

FIG. 8 illustrates, by way of example and not limitation, a DCD embodiment configured to allocate memory in different RAS modes. The total capacity 827 of the DCD may be divided into two regions including a reliable group of memory blocks (e.g., first region 831) which use parity, and a performance group of blocks (e.g., second region 832) which does not use parity. In some embodiments, each memory block may be a combination of RAS mode stripes having continuous DPAs. As the performance mode does not have parity, the physical capacity at the end of a performance mode block may be unused. In the reliable mode, all DPAs can be accessed. For example, out of 256 GB of total capacity 827, the DCD may have 128 GB in the first region 831 for reliable mode and have 128 GB in the second region 832 for performance mode. In response to a request to allocate capacity in a reliable mode to a host, the DCD may allocate capacity from the first region 831, and in response to a request to allocate capacity in a performance mode to a host, the DCD may allocate capacity from the second region 832.

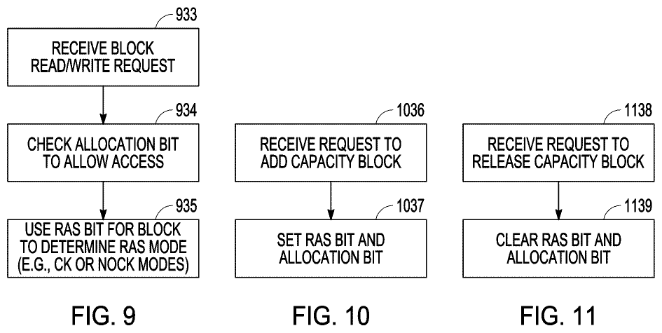

FIG. 9 illustrates, by way of example and not limitation, a method performed by a DCD to process a read or write request to memory. The illustrated method includes receiving a block read or write request at operation 933. At operation 934, the allocation bit in the block index table may be checked to allow access. The RAS bit may be checked to determine the RAS mode for reading or writing the request at operation 935.

FIG. 10 illustrates, by way of example and not limitation, a method performed by a DCD in response to a request to add a capacity block. The DCD may receive a request to add capacity corresponding to a memory block at operation 1036. At operation 1037, the RAS bit and Allocation Bit may be set in the block index table.

FIG. 11 illustrates, by way of example and not limitation, a method performed by a DCD in response to a request to release a capacity block. A request to release a capacity block may be received at operation 1138, and the corresponding RAS bit and allocation bit may be cleared in the block index table at operation 1139.

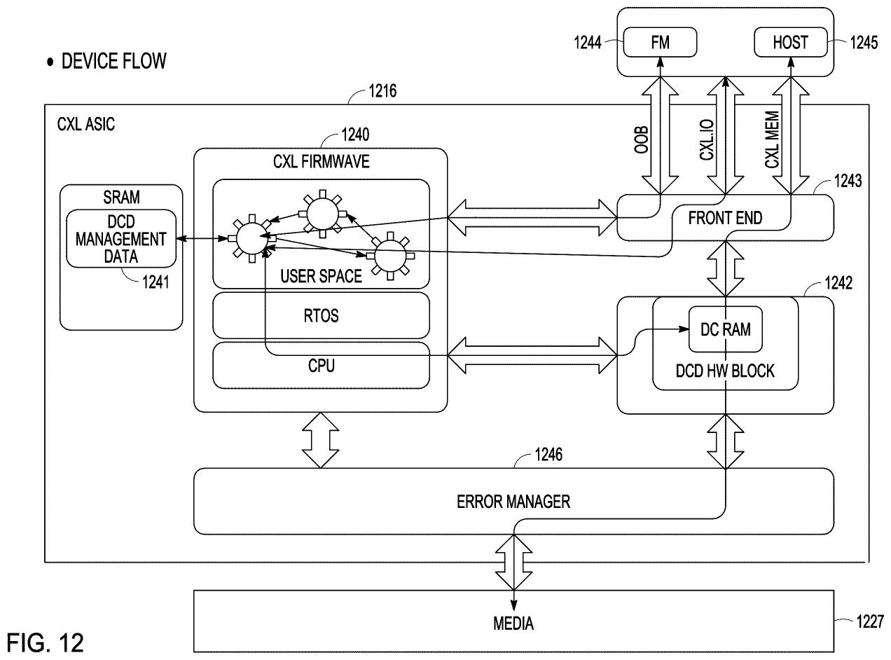

FIG. 12 illustrates, by way of example and not limitation, an embodiment of a DCD along with operational flow. The illustrated DCD 1216 illustrates an application specific integrated circuit (ASIC) view to provide a different view of some of the functions and features of a memory device, such as was discussed for the memory device (e.g., DCD 416) in FIG. 4. The DCD 1216 may include media 1227 which provides the total capacity. The DCD 1216 may include memory processing, which may include CXL firmware 1240 to provide the CXL operations. Static RAM (SRAM) 1241 may be used to cache data for the CXL firmware 1240. The block index table 1242 may be stored in memory. The CXL ASIC may include a front end 1243 configured to interface with the FM 1244 and host 1245. An Error manager 1246 may be used to perform ECC functions.

The FM 1244 uses the out of band (OOB) interface to send commands such as add capacity, release capacity, and the like to the DCD 1216 for the DCD to process using CXL firmware 1240. The CXL firmware may include a central processing unit (CPU), a real time operating system (RTOS) which allows concurrent execution of multiple processes for real time applications, and user space (e.g., code outside of the operating system kernel), The processing performed by the CPU may include managing free or used resources using the SRAM 1241. The CXL firmware 1240 may allocate capacity by updating the block index table 1242. The DCD 1216 may respond back to the host 1215 through this path, such as using CXL.io to inform the host that the capacity is allocated. In an example, CXL.io may be used for the host 1245 to respond back, and for the DCD 1216 to respond to the FM 1244 that the allocation is completed. The host 1245 accesses the capacity using the CXL.mem pathway. Each memory access looks into the block index table 1242 in DC RAM. The host 1245 accesses the capacity by providing the address which has the logical device index (LDI) and host physical address (HPA) information. The HPA is converted into device physical address (DPA), LDI and DPA are used to check the block index table, e.g., in DC RAM, to determine whether this capacity belongs to the host 1245. If the capacity does not belong to the host 1245, the DCD 1216 may respond back that the address is invalid. If the capacity does belong to the host 1245, then the data may be accessed from the media via an error manager 1246.

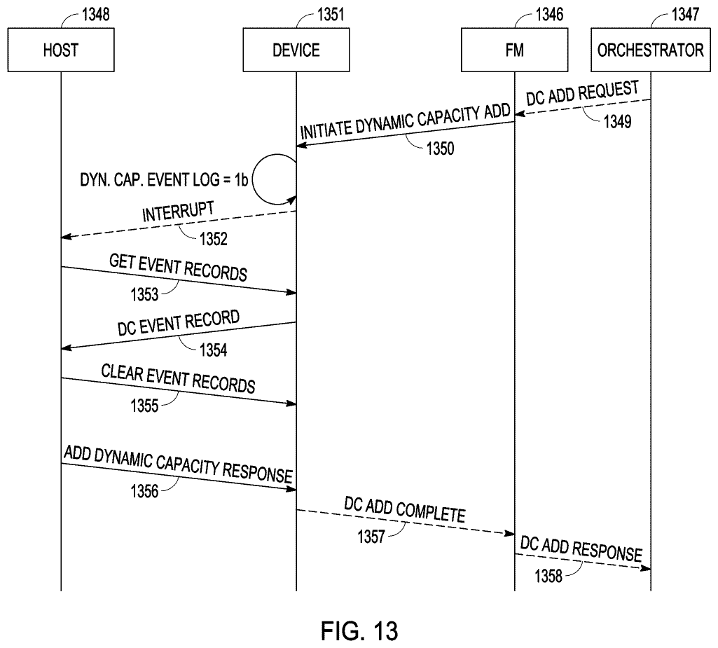

FIG. 13 illustrates, by way of example and not limitation, a flow for dynamically allocating memory for a host. An orchestrator 1347 may be system software which manages allocation and deallocation for a host 1348. An example of an orchestrator 1347 includes Kubernetes, which is an open-source system for automating deployment, scaling, and management of containerized applications. The host 1348 may be running an application and is in need of additional memory. The host 1348 may request the orchestrator 1347 to allocate additional capacity, and the orchestrator 1347 may make the DC Add Request 1349 to the fabric manager (FM) 1346. The FM 1346 initiates a capacity add request 1350 to the device (e.g., DCD 1351) including identifying the logical device or host 1348 which is requesting the capacity. The DCD 1351 determines if it has enough available capacity to allocate the requested additional capacity. If it does not have enough available capacity, the device responds indicating that it has run out of capacity. However, if it does have enough available capacity, the DCD 1351 allocates the capacity to that logical device or host by updating the block index table. The FM 1346 provides device information about how much capacity is requested and provides information about the RAS mode in which the added capacity will operate. This RAS mode information may be requested by the host 1348 and provided to the orchestrator 1347. The capacity may be added by the DCD 1351 sending an interrupt 1352 to the host 1348, receiving a get event records request 1353 from the host 1348, and responding by sending a dynamic capacity event record 1354 to the host 1348. The host 1348 may clear event records 1355 and provide an add dynamic capacity response 1356 to the DCD 1351 to inform the DCD that the add capacity request is completed. The DCD 1351 informs the FM 1346 that the add dynamic capacity request is completed 1357, and the FM 1346 informs the orchestrator 1347 that the add dynamic capacity request is completed 1358. A similar process may be performed when capacity is released by a host. The orchestrator may request the FM 1346 to release capacity and the FM 1346 informs the DCD 1351 that capacity (e.g., dynamic capacity block(s)) is to be deallocated from the logical device. The DCD 1351 updates the block index table to free the block(s) and sends a response to the host 1348 that the change is being made and the host 1348 may acknowledge the change by sending the release command. The DCD 1351 may inform the FM 1346 that the released dynamic capacity request is completed and the FM 1346 may inform the orchestrator 1347.

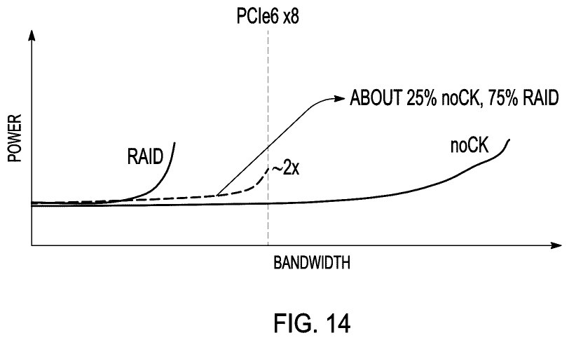

FIG. 14 illustrates, by way of example and not limitation, a relationship between power and bandwidth for Reliable (e.g., RAID, Reed Solomon, CK) and Performance (e.g., CRC, modified RS plus CRC, noCK) RAS modes, and further illustrates a benefit for optimizing capacities in Reliable Mode and Performance Mode. As discussed earlier, capacity may be allocated in different RAS modes (performance or reliability) based on the host's use of the memory. For example, critical data may be allocated in reliable mode and application temporary data may be allocated in performance mode. It is noted that write intensive memory spaces may be tolerant to performance mode RAS capability which will improve system performance because the reliable mode has significantly lower write performance. It is expected that bandwidth may be saturated or nearly saturated by appropriately choosing which memory is allocated in which RAS modes. Example simulation data shows that RAID performance is about 43 GB per second whereas noCK performance is 150 GB per second. As generally illustrated by the dotted line, allocating about 25% of the total capacity as noCK (performance) capacity may saturate or nearly saturate bus bandwidth, such as PCIe6 ×8 bandwidth. Another benefit is flexibility in allocating capacity. The user can have flexibility to allocate memory for applications that are sensitive to reliability and/or performance from the same memory pool or memory device without impacting the overall device bandwidth. Performance per watt may be improved without compromising the reliability by mixing the applications which are reliability sensitive and performance sensitive

Examples, as described herein, can include, or can operate by, logic, components, devices, packages, or mechanisms. Circuitry is a collection (e.g., set) of circuits implemented in tangible entities that include hardware (e.g., simple circuits, gates, logic, etc.). Circuitry membership can be flexible over time and underlying hardware variability. Circuitries include members that can, alone or in combination, perform specific tasks when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time.

A non-transitory machine-readable medium, also referred to as a computer-readable medium, includes instructions, which when executed by a machine, cause the machine to perform functions. The machine-readable medium may include instructions operable to configure an electronic device, such as processing circuitry, to perform methods. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, memories such as non-volatile or volatile memories, random access memories (RAMs) or read only memories (ROMs) as well as memory cards or sticks, hard disks, removable magnetic disks or cassettes, or removable optical disks (e.g., compact disks and digital video disks), and the like. The term “machine-readable medium” is intended to include at least one machine-readable medium such as two or more media which may be in the same device or in different devices, and which may be of the same type of media (such as but not limited to different nonvolatile semiconductor memory arrays) or different type of media (such as but not limited to a volatile semiconductor memory array and a nonvolatile semiconductor memory array). Furthermore, the term “machine” may include at least one processor, including one processor to implement all of the instructions, at least two processors where one processor operates on some of the instructions and other processor(s) operate on other instructions, or at least two processors where each processor is capable of operating on the same instructions. Thus, for example, distributed systems or systems with shared resources are contemplated.

The above detailed description is intended to be illustrative, and not restrictive. The scope of the disclosure should, therefore, be determined with references to the appended claims, along with the full scope of equivalents to which such claims are entitled.

What is claimed is:

1. A system, comprising:
memory including memory blocks; and
a memory device processor configured to dynamically allocate the memory blocks in different RAS (Reliability, Availability and Serviceability) modes that have different power and reliability characteristics, wherein the memory device processor is configured to dynamically allocate a first of the memory blocks in a first RAS mode and dynamically allocate a second of the memory blocks in a second RAS mode.

2. The system of claim 1, wherein the first RAS mode is a reliable mode and the first of the memory blocks includes at least one parity bit, and the second RAS mode is a performance mode and the second of the memory blocks does not include the at least one parity bit.

3. The system of claim 2, wherein the memory device processor is configured to:
write to the first memory block in the reliable mode by reading the first memory block, reading the at least one parity bit for read data, writing data for the first memory block and writing the at least one parity bit for the written data; or
write to the second memory block in the performance mode without reading or checking parity.

4. The system of claim 1, further comprising a block index table configured to identify a dynamic allocation of the memory blocks to logical devices, wherein the memory device processor is configured to:
control access by the logical devices to the memory blocks based on the dynamic allocation identified in the block index table;
receive dynamic capacity requests to change the dynamic allocation; and
update the block index table in response to the dynamic capacity requests.

5. The system of claim 4, wherein the block index table includes RAS bits to identify the different RAS modes, each of the memory blocks corresponds to at least one of the RAS bits in the block index table, and the memory device processor is configured to use the at least one of the RAS bits to determine which one of the different RAS modes is implemented for the corresponding memory block.

6. The system of claim 4, wherein the memory blocks in the memory include a first RAS group that includes at least one of the memory blocks and a second RAS mode group includes at least another one of the memory blocks, the memory device processor is configured to implement the first RAS mode for the at least one of the memory blocks in the first RAS mode group and implement the second RAS mode for the at least the another one of the memory blocks in the second RAS group.

7. The system of claim 6, wherein the memory device processor is configured to:
respond to a request for a first logical device to add dynamic capacity in the first mode by updating the block index table to allocate at least one of the memory devices in the first RAS group to the first logical device; or
respond to a request for the first logical device to add dynamic capacity in the second mode by updating the block index table to allocate the at least another of the memory devices in the second RAS group to the first logical device.

8. The system of claim 1, further comprising:
a dynamic capacity device (DCD), the DCD including the memory and the memory device processor;
at least one host; and
an interface configured to enable the at least one host to access the memory device.

9. The system of claim 8, wherein the system includes a Compute Express Link (CXL) system and the interface includes CXL switches and a fabric manager (FM), wherein the FM is configured to control dynamic capacity requests from the hosts to the memory device processor.

10. A method implemented using a memory device processor and a memory that includes memory blocks, the method comprising:
using the memory device processor to dynamically allocate the memory blocks in different RAS (Reliability, Availability and Serviceability) modes that have different power and reliability characteristics, including dynamically allocating a first of the memory blocks in a first RAS mode and dynamically allocate a second of the memory blocks in a second RAS mode.

11. The method of claim 10, wherein the first RAS mode is a reliable mode and the first of the memory blocks includes at least one parity bit, and the second RAS mode is a performance mode and the second of the memory blocks does not include the at least one parity bit.

12. The method of claim 11, further comprising using the memory device processor to:
write to the first memory block by reading the first memory block, reading the at least one parity bit for read data, writing data for the first memory block and writing the at least one parity bit for the written data; or
write to the second memory block in the performance mode without reading or checking parity.

13. The method of claim 10, further comprising identifying a dynamic allocation of the memory blocks to logical devices using a block index table, and using the memory device processor to:
control access by the logical devices to the memory blocks based on the dynamic allocation identified in the block index table;
receive dynamic capacity requests to change the dynamic allocation; and
update the block index table in response to the dynamic capacity requests.

14. The method of claim 13, wherein the block index table includes RAS bits to identify the different RAS modes, each of the memory blocks corresponds to at least one of the RAS bits in the block index table, and the method further includes using the memory device processor to determine, based on the at least one of the RAS bits, which one of the different RAS modes is implemented for the corresponding memory block.

15. The method of claim 13, wherein the memory blocks in the memory include a first RAS group that includes at least one of the memory blocks and a second RAS mode group includes at least another one of the memory blocks, the method further includes using the memory device processor to implement the first RAS mode for the at least one of the memory blocks in the first RAS mode group and implement the second RAS mode for the at least the another one of the memory blocks in the second RAS group.

16. The method of claim 15, further comprising using the memory device processor to:
respond to a request for a first logical device to add dynamic capacity in the first mode by updating the block index table to allocate at least one of the memory devices in the first RAS group to the first logical device; or
respond to a request for the first logical device to add dynamic capacity in the second mode by updating the block index table to allocate the at least another of the memory devices in the second RAS group to the first logical device.

17. The method of claim 10, wherein the method is implemented using:
a dynamic capacity device (DCD), the DCD including the memory and the memory device processor;
at least one host; and
an interface configured to enable the at least one host to access the memory device.

18. The method of claim 17, wherein the method is implemented using a Compute Express Link (CXL) system and the interface includes CXL switches and a fabric manager (FM), and the method includes using the FM to control dynamic capacity requests from the hosts to the memory device processor.

19. A non-transitory machine-readable medium including instructions which, when executed by processing circuitry, cause the processing circuitry to perform operations comprising dynamically allocating memory blocks in different RAS (Reliability, Availability and Serviceability) modes that have different power and reliability characteristics, including dynamically allocating a first of the memory blocks in a first RAS mode and dynamically allocating a second of the memory blocks in a second RAS mode.

20. The non-transitory machine-readable medium of claim 19, wherein the first RAS mode is a reliable mode and the first of the memory blocks includes at least one parity bit, the second RAS mode is a performance mode and the second of the memory blocks does not include the at least one parity bit, and the operations performed by the processing circuitry includes:
writing to the first memory block in the reliable mode by reading the first memory block, reading the at least one parity bit for read data, writing data for the first memory block and writing the at least one parity bit for the written data; or
writing to the second memory block in the performance mode without reading or checking parity.
